(19) United States
(12) Patent Application Publication
(10) Pub. No.: US 2025/0302236 A1
(43) Pub. Date: Oct. 2, 2025

(54) APPLIANCE FOR PREPARING SCRAMBLED EGGS

(71) Applicant: Marcelo Oliveira Lemos, Belo Horizonte (BR)

(72) Inventor: Marcelo Oliveira Lemos, Belo Horizonte (BR)

(21) Appl. No.: 18/842,416

(22) PCT Filed: Jan. 23, 2023
(86) PCT No.: PCT/BR2023/050025

§ 371 Date: Aug. 29, 2024

(30) Foreign Application Priority Data
Jan. 24, 2022 (BR) 1020220013217

(51) Int. Cl. A47J 43/044; A47J 27/00; A47J 36/02; A47J 36/32; A47J 43/07; B01F 27/053; B01F 27/054; B01F 27/112; B01F 27/806; B01F 27/90; B01F 35/221; B01F 35/90; B01F 35/93; B01F 101/06

(52) U.S. Cl. CPC A47J 43/044; A47J 27/004; A47J 36/025; A47J 36/32; A47J 43/0711; B01F 27/053; B01F 27/054; B01F 27/112; B01F 27/806; B01F 27/90; B01F 35/221422; B01F 35/2215; B01F 35/22161; B01F 35/93; A47J 2043/04481; B01F 2035/99; B01F 2101/06

(57) ABSTRACT

The invention relates to a compact device for the automated preparation of scrambled eggs, with customizable settings for time (6), temperature (7) and speed (8) for different types of recipes and textures, consisting of a motor (2) that generates the movement of a working tool (3A; 3B) inside a non-stick container (4) coupled to a heating base (5).

### TECHNICAL FIELD

The present invention consists of an apparatus whose objective is to automate the culinary preparation of different types of scrambled eggs, for both domestic and commercial use.

### PRIOR ART

Currently, scrambled eggs are prepared manually, using a heated pan or frying pan, eggs, salt, butter or another type of fat, and, in some cases, other ingredients to taste. The technique consists of placing all the ingredients in the utensil under heating and moving a work tool, such as a spatula or whisk, until the ideal point is obtained, taking into account temperature, time and type of movement. In research carried out, technologies in the area constitute machinery for preparing scrambled eggs on an industrial scale, not applicable for domestic use, and generic culinary preparation, such as patent ns BR 102016008561-6 A2, a larger appliance for use in confectionery, which includes two heating sources, one in the mixing bowl and the other in the support area, a motor for driving the rotation of a work tool in the mixing bowl. The device requires monitoring during the preparation time and was designed to melt a food, such as chocolate, in one compartment and be manually added to the other to be mixed.

### DESCRIPTION OF THE INVENTION

With the aim of automating the specific preparation of different types of scrambled eggs, eliminating the need for a person to perform the task, the present invention was developed. It is known that, to achieve the ideal texture of this food, technique is required, with specific movement, time and temperature for each type of recipe, which can be achieved with the invention. It is a compact, portable device with low manufacturing cost and industrial feasibility for production. It values practicality and is easy to use. It has an audible signal and a light indicating when it is running and when it is finished. The preparation container, with a non-stick interior, reduces or eliminates the use of fat, making the product an ally tool for a healthy daily diet.

### BRIEF DESCRIPTION OF THE FIGURES

The invention can be better understood through the following detailed description in accordance with the attached figures. However, the design presented here is only intended to exemplify one of the ways of carrying out the invention, and should not be considered, however, its only form of implementation.

FIG. 1 shows the front view of the device.

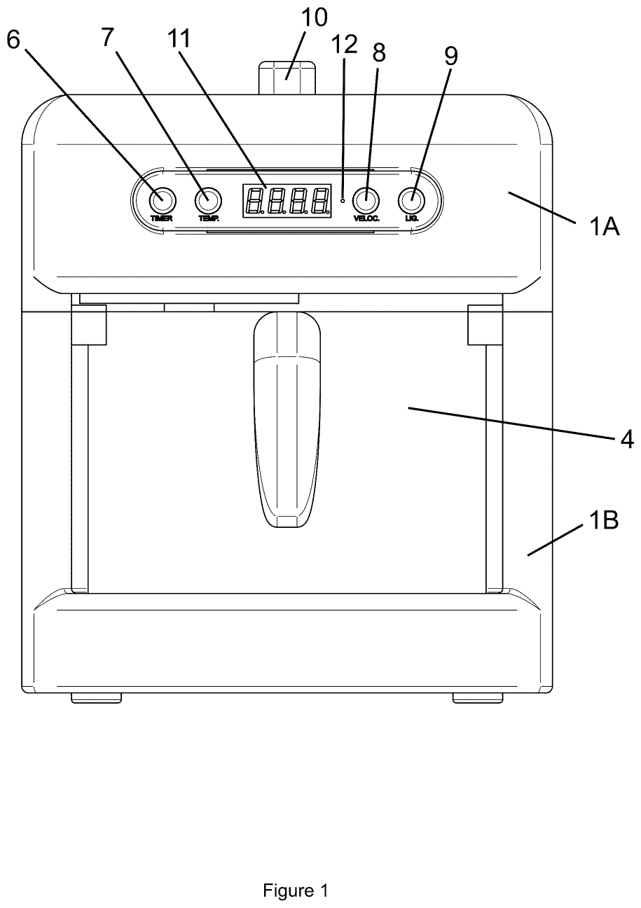

FIG. 2 shows the oblique view of the device.

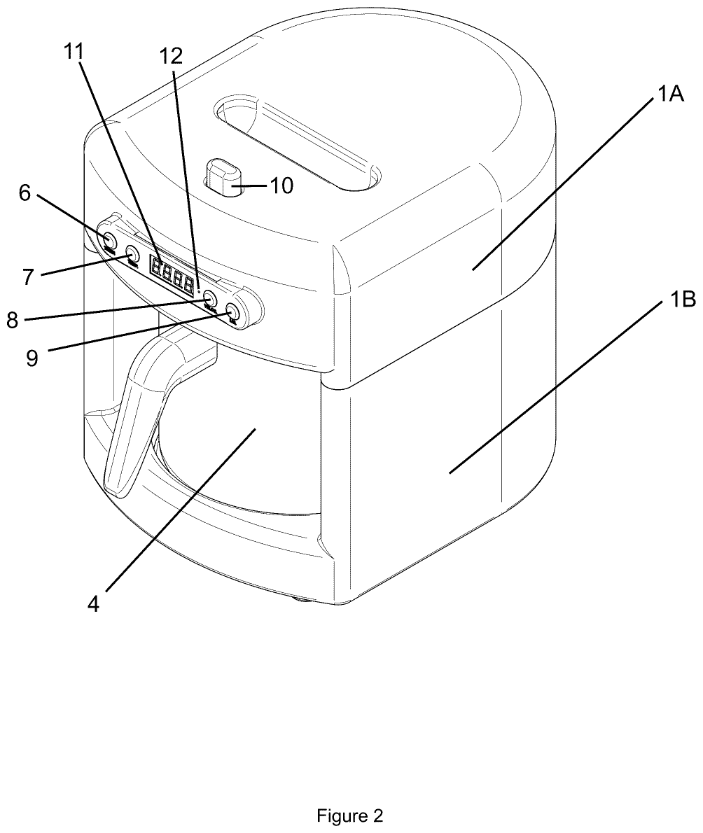

FIG. 3 shows the oblique view with the longitudinal section of the device.

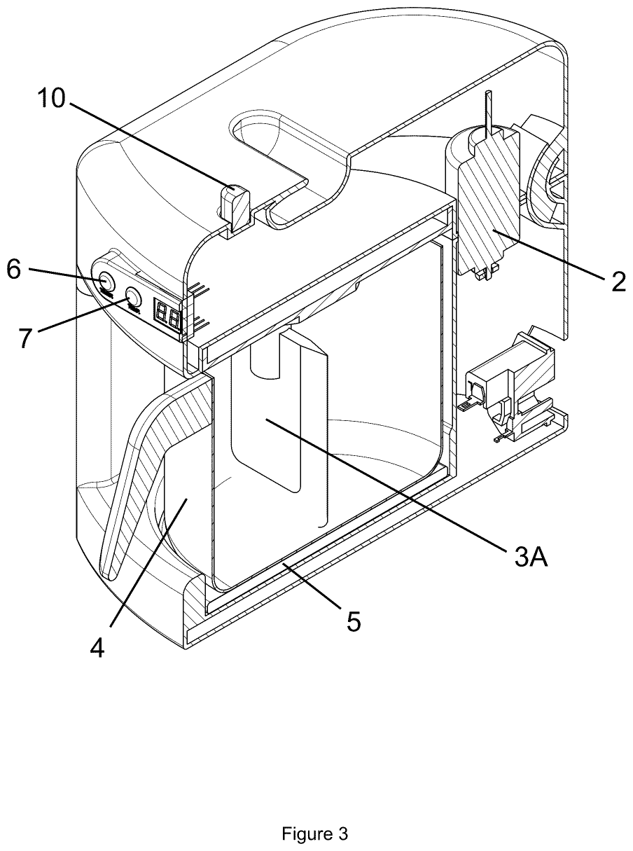

FIG. 4 shows the oblique view of the device with the upper compartment open.

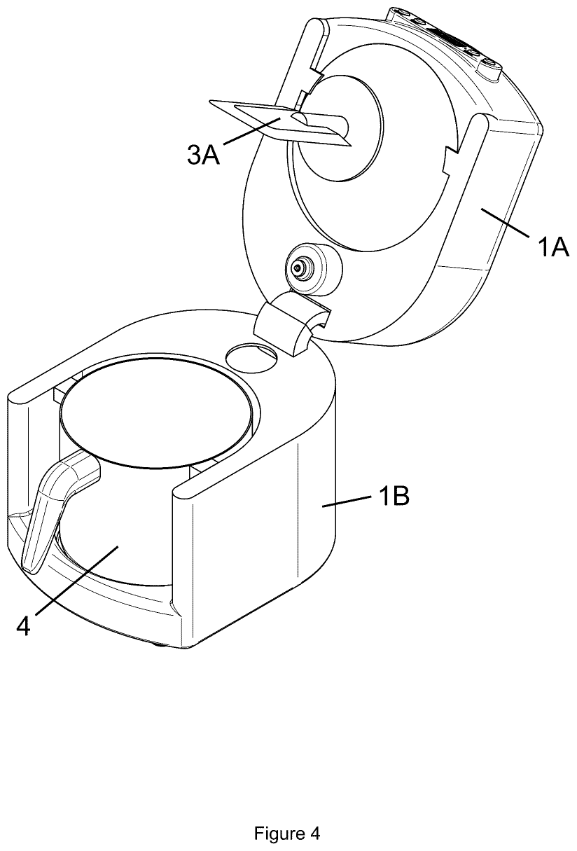

FIG. 5 shows an oblique view of the device with the top compartment open and accessories on the side.

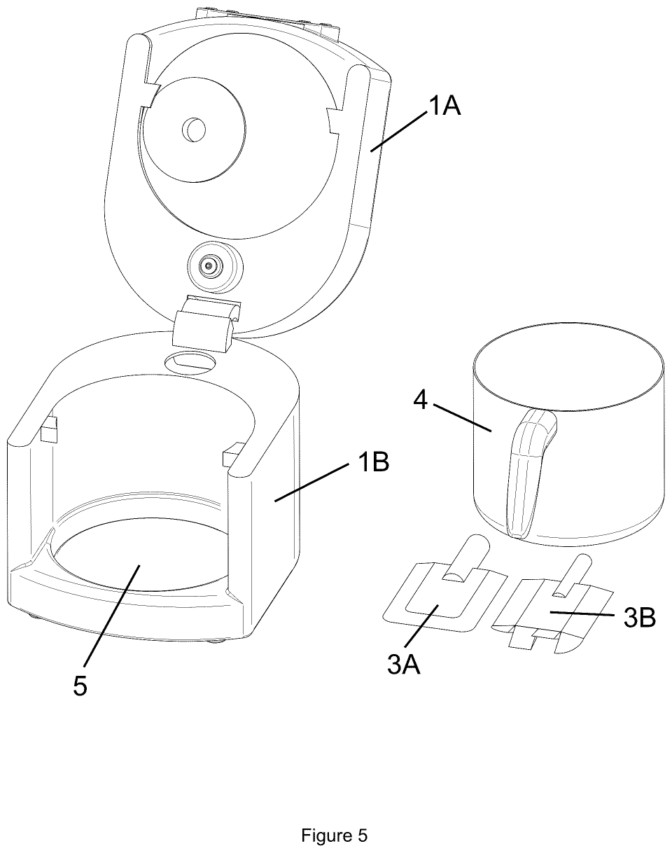

FIG. 6 shows the oblique view of the work tools.

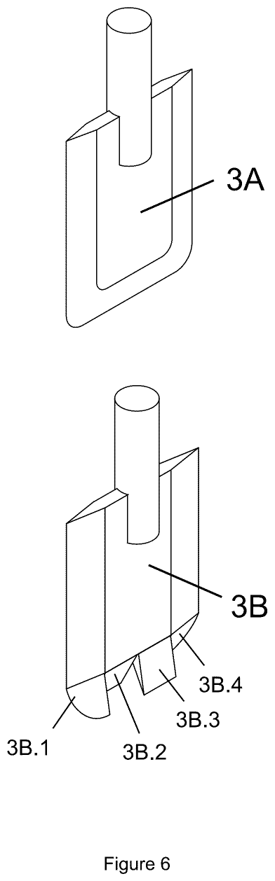

### DETAILED DESCRIPTION OF THE INVENTION

The invention was created for the culinary preparation of scrambled eggs. It preferably consists of a casing (1 A; 1 B), the upper part of which preferably houses a rotation motor (2), preferably powered by electrical energy, which promotes the movement of one of the work tools (3A; 3B), type silicone spatula, inside a container preferably cylindrical in shape with a handle (4), milk boiler type, non-stick on the inside, preferably coupled to a heating surface (5), preferably in the lower part of the casing (1 B).

With the casing open, one of the work tools (3A; 3B) is attached to its upper part and the container (4) is fitted, with the eggs and other ingredients, onto the heating base (5). The upper part (1 A) is closed over the lower part (1 B), so that the working tool (3A; 3B) comes into contact, exerting pressure, with the bottom and the inner side of the container (4), which is preferentially locked on the lower base.

Control buttons with adjustment of time, timer (6), temperature (7) and rotation speed (8), preferably located on the upper front part of the device (1A), are customized to obtain different types of recipes and textures of scrambled eggs. Light (11) and sound (12) indicating operation are also preferably located on the upper front part.

Once the preparation time (6), temperature (7) and movement speed (8) have been configured, press the on button (9) to start the appliance. The light (11) comes on and a sound (12) is emitted to indicate the start of heating of the lower support (5) and the rotation of the spatula (3A;3B) inside the container (4). After the chosen preparation time has elapsed, an audible warning (12) and a light warning (11) indicate the end of the procedure. Press the unlock button (10) to open the upper part of the casing (1 A), allowing the spatula (3A;3B) to be released and the container (4) to be removed.

The device casing (1 A; 1 B) allows the container (4) to be isolated, protects the preparation and prevents external interference, providing safety to the user when closed

The work tools (3A; 3B) that accompany the product resemble a spatula, being composed, at the bottom, of a silicone paddle with flexible edges and, at the top, of a rod to be coupled to the rotation mechanism to exert movement inside the container (4). They withstand high temperatures and generate adequate pressure on the side and bottom of the cylindrical container (4), preventing food from clumping and scratches on the non-stick internal part. They are chosen according to the recipe and, at the end of preparation, they are uncoupled to help remove the food from the container (4).

1. Appliance for preparing scrambled eggs composed of a casing (1A; 1 B), the upper part of which preferably houses a rotation motor (2), preferably powered by electrical energy, which promotes the movement of one of the working tools (3A; 3B), silicone spatula type, inside a container preferably cylindrical in shape with handle (4), boiling type, non-stick on the inside, preferably coupled to a heating surface (5), preferably on the lower part of the casing (1 B), also including control buttons with time adjustment, timer (6), temperature (7), rotation speed (8), on/off button (9), unlock button (10), Light (11) and speaker (12) to indicate the operation on the upper front, characterized by automating the specific preparation of different types of scrambled eggs, combining temperature, time, speed and type of movement applied by the working tool (3A or 3B) to achieve the ideal texture of scrambled eggs, applying technique with specific movement, time and temperature for each type of recipe.

2. Appliance for preparing scrambled eggs according to claim 1, characterized in that said work tool (3A) supports high temperatures and has a special shape in order to maintain adequate pressure in relation to the internal part of the container (4), being composed, in the lower part, of a silicone paddle with flexible edges and, in the upper part, of a rod to be coupled to a rotation mechanism, in order to exert movement inside the container (4).

3. Appliance for preparing scrambled eggs according to claim 1, characterized in that it contains a working tool (3B) made of silicone with flexible edges, having alternating chamfers (3B.1, 3B.2, 3B.3, 3B.4) that perform the controlled scraping movement of the container (4), specifically designed to break the coagulation of the egg when heated, applying pressure to the side and bottom of the container, supporting high temperatures and, in its upper part, featuring a rod to be coupled to a rotation mechanism, in order to exert movement within the container (4).

4. Appliance for preparing scrambled eggs according to claim 1, characterized in that said container (4), with a cylindrical shape and non-stick internal surface, has a low thickness, in order to transfer heat adequately to the egg mixture without burning the food due to excess heat transferred.

5.-13. (canceled)
